(19) United States
(12) Patent Application Publication
(10) Pub. No.: US 2010/0212431 A1
(43) Pub. Date: Aug. 26, 2010

(54) Method and apparatus for the non-destructive material testing of a test object using ultrasonic waves

(76) Inventors: Michael Clossen-Von Lanken Schulz, Issum (DE); Michael Opheys, Nettetal (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/681,907

(22) PCT Filed: Sep. 10, 2008
(86) PCT No.: PCT/EP2808/061999

§ 371 Date: Apr. 7, 2010

(30) Foreign Application Priority Data
Oct. 18, 2007 (EP) 07020440.9

(51) Int. Cl. G01N 29/00

(52) U.S. Cl. 73/632

(57) ABSTRACT

A method for the non-destructive material testing of a test object that is at least sectionally solid by subjecting the test object to ultrasonic waves and capturing the ultrasonic waves reflected within the test object is provided. The method includes computer-supported division of the test object into a predetermined number of volume elements, subjecting the test object to a sound field while scanning the surface of at least a section of a surface of the test object, detecting the sound waves reflected on the volume elements while scanning the surface or the section of the surface of the test object, and in-phase addition of the sound waves reflected at the same volume elements and detected at measuring positions on the surface of the test object. A central beam is directed at the volume element in each measuring position, wherein the central beam has the maximum intensity of the sound field.

### CROSS REFERENCE TO RELATED APPLICATIONS

This application is the US National Stage of International Application No. PCT/EP2008/061999, filed Sep. 10, 2008 and claims the benefit thereof. The International Application claims the benefits of European Patent Office application No. 07020440.9 EP filed Oct. 18, 2007. All of the applications are incorporated by reference herein in their entirety.

### FIELD OF INVENTION

The invention relates to a method for non-destructive material testing as claimed in the claims. The invention furthermore relates to a corresponding apparatus as claimed in the claims. The invention additionally relates to an apparatus for examining an object inside a human or animal body as claimed in the claims.

### FIELD OF INVENTION

In the case of numerous solid and partially solid components and intermediate products it is necessary to examine their internal structure for material defects. For this purpose, non-destructive test methods are required, which provide information relating to the internal structure, which cannot be seen. This is necessary especially in the case of components which are subject to great mechanical stress.

By way of example, components of steel are forged after being cast, in order to be brought into their final shape by way of turning. Here, the test for internal material defects can be carried out as early as after the forging operation.

Typically, such metal parts are tested using ultrasound. In the process, the sound waves which are reflected on boundary surfaces inside the material are detected. Using the travel time of the reflected sound wave, the path length it has traveled can be determined. Insonification from various directions can be used to gather further information relating to the material defect(s). On the basis of this information, it is possible to locate material defects, for example. For example, the geometric alignment of the material defect can be determined in this manner. Conclusions as to the type of the material defect can be drawn from the shape of the reflected sound waves.

The volume which is accessible to the ultrasound can be examined in its entirety by way of scanning the surface of the test object using an ultrasound detector and of recording of the detected data. An image which can be used for examination purposes can be generated on the basis of the detected data.

There are several possibilities for determining the size of the material defects. For example, it is possible to directly read off the extent of the material defect during the scanning operation. However, to do this it is necessary that the spatial resolution is smaller than the physical extent of the material defect. The spatial resolution is limited by the wavelength which is used and the size of the aperture and thus by the diffraction of the sound waves.

The size of the material defect can also be determined by way of the amplitude of the reflected signal. This also allows determination of the size of those material defects which are smaller than the spatial resolution of the method. The amplitude of the reflected signal also depends, however, on other parameters, for example on the orientation of the material defect or the reflection properties at the boundary surface.

The amplitude of the reflected signal decreases with decreasing size of the material defect. In this case, the distance of the interference signals becomes too small to be able to identify the material defect from a single amplitude/travel time diagram. A distance of +6 dB is expediently required between the measurement signal and the interference signal.

The spatial resolution can be optimized by focusing the sound waves with the aid of suitable test heads. In this process, the focusing can become narrower the wider the test head in relation to the wavelength. The focusing causes a higher sound pressure.

Therefrom it is possible to determine the position of the material defect and, in the case of an extended material defect, also the size thereof within the framework of the resolution. The accuracy is approximately comparable to that in the scanned region in the aforementioned method which uses the focused sound waves.

The synthetic aperture focusing technique (SAFT) is a method which assigns a three-dimensional representation to a mechanical two-dimensional scan of the test object. Here, the test object is scanned in a two-dimensional manner. This is done, for example, along a meandering path. The data are stored together with positional data of the test object for the further evaluation. The test object is divided into small volume elements, such as into cubes. The volume elements are covered with sums of echo signal components which originate from various positions of the test head in the two-dimensional scan.

With the SAFT method, all the reflected signal components which are feasible in each pixel in an expected defect region are added with a time shift that the signal components would have if the pixel were the source of a reflected wave. The time shift that corresponds to the phase angle results from the geometric relationships between the test head and the pixel, particularly from the distance between the test head and the pixel. If the pixel is now actually the source of a reflected wave, the amplitude increases at this site with the number of the various positions of the test head from which the material defect was detected. For all other pixels, the phases do not correspond, and so the sum approaches zero in an ideal case, but is at least very small.

The spatial resolution in the SAFT method is not limited by the measurements of the test head, and as a result high spatial resolution can be achieved. In principle, this is a focusing method in which the limit of resolution results from the wavelength and the synthetic aperture. The synthetic aperture is determined by the angular range from which the material defect is detected. The aperture is limited by the movement of the test head and the divergence of the sound field.

In the SAFT method, all beams in a divergence bundle are taken into consideration and not just the central beams. Since the data are recorded with high frequencies, it is also possible in the addition of the data to take into consideration the phase. As a function of the phase, echo signals can cancel each other out in the case of destructive interference and increase in the case of constructive interference.

According to the prior art, all echo signals are subject to the same consideration, independent of their position within the divergence bundle. As a result, the echo signals of the edge beams undervalue a reflector by the factor “2” with the same reflectivity. The factor “2” corresponds to a distance of 6 dB. The echo signals of the edge beams result in a falsification of the echo sums calculated for the individual volume portions. The portions of the echo signals which do not originate from the central beam are essential components in the SAFT method.

Only if the sound field is known exactly is it possible to correct these portions. In practice, this is not completely possible, and so the results are always subject to error. Subsequent evaluation of the obtained data according to the distance-gain-size method (DGS method) is not possible, since the DGS method presupposes the exact knowledge of the echo amplitude.

In the DGS method, starting from the amplitude, the material defect is assigned an equivalent reflector size that would produce a vertically insonified free circular surface. When the detected signal is substantially greater than the interference signal or noise signal, there is no problem in evaluating the amplitude using the DGS method. In this case, the reflector must be located on the central beam of the sound field of the test head. From the dependence of the amplitude on the distance from the test head, the detected amplitude corresponds to a reflector size with known geometry and orientation relative to the central beam. If, by contrast, the detected amplitude is smaller than the noise signal or of a comparable order of magnitude, the material defect cannot be identified from the amplitude/travel time diagram.

### SUMMARY OF INVENTION

It is an object of the invention to make available an improved method and a corresponding apparatus for the non-destructive material testing of a test object using ultrasound waves.

This object is achieved, with respect to the method, by the subject matter in accordance with the claims.

It is provided in accordance with the invention that in each measurement position, a central beam is directed onto the volume element, wherein the central beam has the maximum intensity of the sound field.

The essence of the invention is a modified SAFT method, in which the central beam having the maximum intensity of the sound field is directed onto the volume element. In this manner, the portions of the echo signals emanating from edge beams play no role and have no part in any falsifications of the measurement result.

Provision is preferably made for the central beam to be electronically directed onto the volume element. This enables rapid and precise implementation of the method.

Advantageously, the direction of the central beam can be two-dimensionally changed. This ensures that the central beam can be directed onto the volume element in the case of all geometric shapes of the test object.

A test head comprising a multiplicity of ultrasound sources is used, for example, for subjecting the test object to ultrasound. The individual ultrasound sources can be electronically driven particularly easily. In particular, the test head is an antenna array element.

Subsequently, the added-up sound waves are evaluated according to the distance-gain-size method (DGS method).

It is furthermore provided for the surface or at least the surface section of the test object to be scanned according to a predetermined scheme.

In particular, the surface or at least the surface section of the test object is completely scanned.

By way of example, the method is provided for the material testing of a test object made of metal. In particular, but not exclusively, the method can be used for the material testing of a forged component.

Additionally, the method can be provided, in addition to the non-destructive material testing, in a corresponding manner for medicinal and medico-technological applications. In this case it is possible, for example, to examine the internal structure of the human or animal body from the outside. In particular, tumors or other constitutional changes inside the body can be found and located. The method furthermore enables foreign bodies to be examined, which have been inserted in the human or animal body for treatment purposes. For example, attachment elements that were inserted in order to join bone fractures can be examined in this manner.

The object on which the invention is based is achieved, with respect to the apparatus, by the subject matter in accordance with the claims.

The invention provides for a central beam emanating from the test head to be able to be aligned with the volume element, wherein the central beam has the maximum intensity of the sound field.

Since the central beam having the maximum intensity of the sound field is directed onto the volume element, the portions of the echo signals emanating from edge beams play no role and have no part in any falsifications of the measurement result.

The central beam can preferably be electronically aligned with the volume element. This enables rapid and precise implementation of the method.

By way of example, the test head has a multiplicity of ultrasound sources. The individual ultrasound sources can be electronically driven particularly easily. In particular, the test head is an antenna array element.

The object on which the invention is based is achieved, accordingly, for an apparatus for examining an object inside a human or animal body, by the subject matter in accordance with the claims.

According to the invention, it is likewise provided that a central beam emanating from the test head can be aligned with the volume element, wherein the central beam has the maximum intensity of the sound field.

Since the central beam having the maximum intensity of the sound field is directed onto the volume element, the portions of the echo signals emanating from edge beams play no role in this application either and have no part in any falsifications of the measurement result.

The central beam can preferably be electronically aligned with the volume element. This enables rapid and precise examination to be carried out.

Preferably, the test head comprises a multiplicity of ultrasound sources. The individual ultrasound sources can be electronically driven particularly easily. In particular, the test head is an antenna array element.

Further features, advantages and special embodiments of the invention are subject matter of the dependent claims.

### BRIEF DESCRIPTION OF THE DRAWINGS

The method according to the invention will be explained in more detail below in the description of the figures with reference to preferred embodiments and using the attached drawings, in which:

FIG. 1 shows a schematic lateral section view of a test object and of a test head according to a preferred embodiment of the method according to the invention,

FIG. 2 shows a schematic lateral section view of the test object and three positions of the test head in an unaligned state according to the preferred embodiment of the method according to the invention, and FIG. 3 shows a schematic lateral section view of the test object and of the three positions of the test head in an aligned state according to the preferred embodiment of the method according to the invention.

### DETAILED DESCRIPTION OF INVENTION

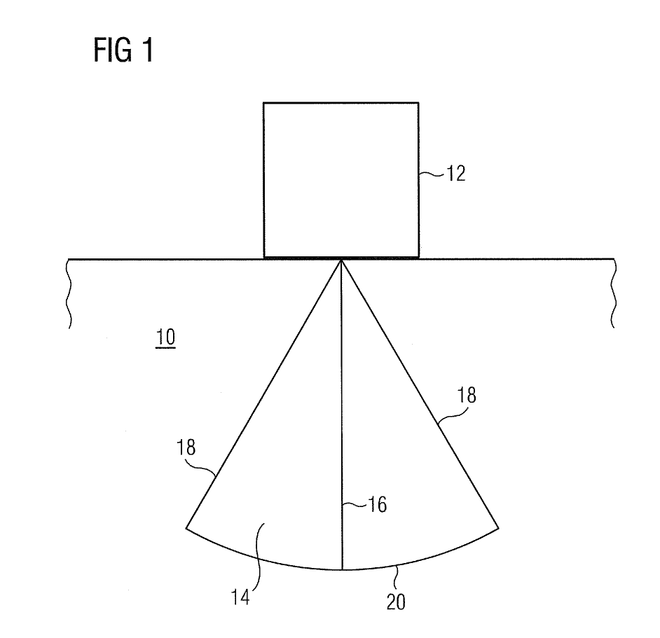

FIG. 1 shows a schematic lateral section view of a test object 10 and of a test head 12. A cone-shaped sound field 14 emanates from the test head 12 and penetrates into the test object 10. The sound field 14 comprises a central beam 16 and a multiplicity of edge beams 18. The edge beams 18 are defined by a weakening by −6 dB. Additionally, the sound field 14 comprises further beams between the central beam 16 and the edge beams 18.

The sound field 14 furthermore comprises a wavefront 20 which has the shape of a sphere surface section. The sound field 14 forms a divergence bundle.

The material test is carried out by moving the test head 16 at the external surface of the test object 10. FIG. 1 illustrates that a radial sound wave 22 is reflected particularly strongly on the tangential material defect 18, since the tangential material defect 18 is aligned substantially parallel to the surface of the test object 10. It also illustrates that a tangential sound wave 24 is reflected particularly intensively on the radial material defect 18.

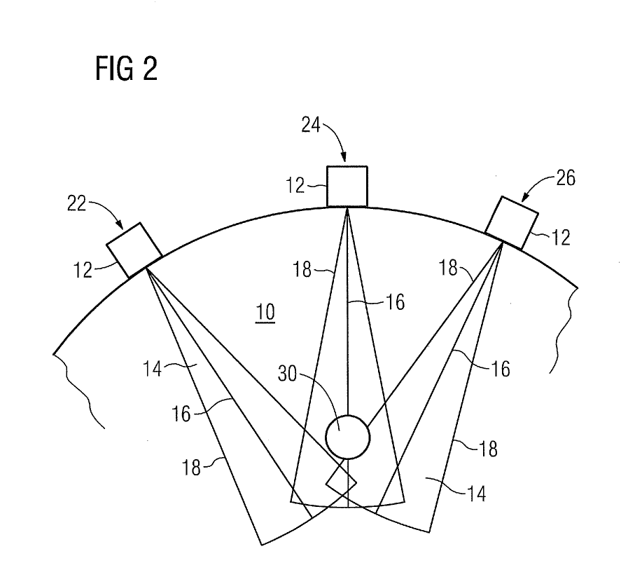

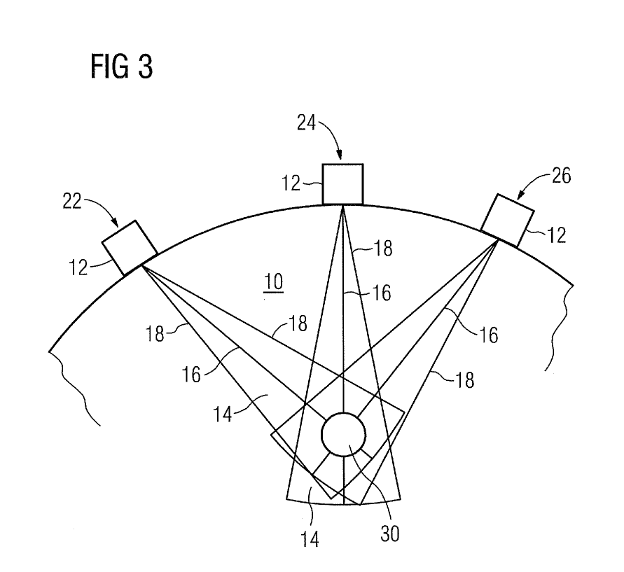

FIG. 2 shows a schematic lateral section view of the test object 10 and of several positions of the test head 12 in an unaligned state according to the preferred embodiment of the method according to the invention.

The test head 12 is shown at a first test head position 22, a second test head position 24 and at a third test head position 26 at the test object 10. In all three test head positions 22, 24 and 26, the test head 12 is located at the surface of the test object 10. In this example, the test object 10 has a curved surface. At each test head position 22, 24 and 26, the test head 12 generates a sound field 14 having in each case one central beam 16 and a multiplicity of edge beams 18. Further beams are located between the central beam 16 and the edge beams 18.

Located inside the test object 10 is a volume element 30. The sound field 14 which emanates from the first test head position 22 travels past the volume element 30. The sound field 14 which emanates from the second test head position 24 strikes the center of the volume element 30 by way of its central beam 16. The sound field 14 which emanates from the third test head position 26 strikes the volume element 30 by way of one of its edge beams 18. Only those beams that strike the volume element 30 make a contribution.

The portions of the echo signals for the different test head positions 22, 24 and 26 are added up in accordance with the position taking into account the phase. In this case, the portion of the echo signal coming from the central beam 16 of the second test head position 24 is a correct contribution for the sum. However, the portion of the echo signal coming from the edge beam 18 of the third test head position 26 is false, that is to say too low. The central beam 16 emanating from the second test head position 24 would be incorporated correctly in the calculation. However, the edge beam 18 emanating from the third test head position 26 would be incorporated in the calculation as including errors. The further beams coming from the second test head position 24 would also be incorporated in the calculation in their false states.

The unaligned state of the central beams 16 also corresponds to the alignment in a conventional method.

FIG. 3 shows a schematic lateral section view of the test object 10 and the three positions of the test head 12 from FIG. 2 in an aligned state in accordance with the preferred embodiment of the method according to the invention.

Contrary to FIG. 2, all three central beams 16 in FIG. 3 are directed onto the volume element 30. As a result, the portions of the echo signals coming from the edge beams 18 disappear. This eliminates a source of errors.

The method according to the invention can be used to electronically change the direction of the central beam 16 from the test head 12 such that the central beam 16 is actuated into a desired direction. This is done with the aid of antenna array technology. If a two-dimensional antenna array element is used, the central beam 16 is electronically changed two-dimensionally in terms of its direction in small rasterization.

In the method according to the invention, each volume element 30 is struck in each case by the central beam 16 from the different test head positions 22, 24 and 26. In this way, the summation is effected automatically with the correct weighting.

The results obtained in this manner can also be evaluated according to the DGS method. The relatively large amount of data can be recorded and stored without any problems.

When programming the alignment of the test head 12, the direction-dependent sensitivity is already taken into consideration during the measurement, by setting an angle-amplitude correction (AAC).

In the case of the antenna array technology, an antenna array test head 12 is used, in which the angle range can be set electronically. It is possible by way antenna array test head 12 for a substantially larger volume to be scanned than with a conventional test head 12.

Additionally, the method in accordance with the invention can be provided not only for the non-destructive material testing but also in a corresponding manner for medical and medico-technological applications.

In this case it is possible, for example, to examine the internal structure of the human or animal body from the outside. In particular, tumors or other constitutional changes or diseases inside the body can be found and located.

The method furthermore enables foreign bodies to be examined, which have been inserted in the human or animal body for treatment purposes. For example, attachment elements that were inserted in order to join bone fractures can be examined in this manner.

The method according to the invention results in a greater spatial resolution and enables evaluation using the DGS method. This leads to an improved evaluation of material defects.

1.-15. (canceled)

16. A method for the non-destructive material testing of a test object which is solid at least in sections by subjecting the test object to ultrasound waves and detecting the ultrasound waves which are reflected within the test object, comprising:
dividing, using a support of a computer, the test object into a predetermined number of volume elements;
subjecting the test object to a sound field during a scanning operation of a surface or at least of a surface section of the test object;
detecting the ultrasound waves reflected on the predetermined number of volume elements during the scanning operation of the surface or at least of the surface section of the test object; and
in-phase adding the ultrasound waves which are reflected on the same volume elements and are detected at a plurality of measurement positions on the surface of the test object,
wherein for each measurement position, a central beam is directed onto a volume element,
wherein the central beam has a maximum intensity of the sound field,
wherein a plurality of edge beams each include half the maximum intensity of the sound field, and
wherein in a programming of an alignment of the test head, a direction-dependent sensitivity is already taken into consideration in the measurement by setting an angle-amplitude correction.

17. The method as claimed in claim 16, wherein the central beam is electronically directed onto the volume element.

18. The method as claimed in claim 17, wherein a direction of the central beam may be two-dimensionally changed.

19. The method as claimed in claim 16,
wherein a test head includes a plurality of ultrasound sources, and
wherein the test head is used to subject the test object to ultrasound.

20. The method as claimed in claim 19, wherein the test head is an antenna array element.

21. The method as claimed in claim 16, wherein the added-up ultrasound waves are evaluated according to a distance-gain-size method.

22. The method as claimed in claim 16, wherein the surface or at least the surface section of the test object is scanned according to a predetermined scheme.

23. The method as claimed in claim 16, wherein the surface or at least the surface section of the test object is completely scanned.

24. The method as claimed in claim 16, wherein the method is used for the material testing of a test object made of metal.

25. The method as claimed in claim 16, wherein the method is used for the material testing of a forged component.

26. The method as claimed in claim 16, wherein the method is used for the external testing of a human or animal body.

27. The method as claimed in claim 26, wherein the method is used to examine a foreign body within the human or animal body.

28. An apparatus for the non-destructive material testing of a test object, comprising:
a test head,
wherein the test object is solid at least in sections and is divided, in a computer-supported fashion, into a predetermined number of volume elements,
wherein the test head subjects the test object to a sound field during a scanning operation of the surface or at least of a surface section of the test object and detects the sound waves reflected on the predetermined volume elements during the scanning operation of the surface or at least of the surface section of the test object,
wherein a central beam emanating from the test head may be aligned with a volume element,
wherein the central beam has a maximum intensity of the sound field and a plurality of edge beams have in each case half the maximum intensity of the sound field, and
wherein an alignment of the test head is programmed such that a direction-dependent sensitivity is already taken into consideration in a measurement by setting an angle-amplitude correction.

29. The apparatus as claimed in claim 28, wherein the central beam may be electronically aligned with the volume element.

30. The apparatus as claimed in claim 29, wherein a direction of the central beam may be two-dimensionally changed.

31. The apparatus as claimed in claim 28, wherein the test head is configured as an antenna array element.

32. The apparatus as claimed in claim 28, wherein the test head comprises a plurality of ultrasound sources.

33. The apparatus as claimed in one of claims 28,
wherein an object inside a human or animal body is provided as the test object, the body is divided in a computer-supported manner into a predetermined number of volume elements, and
wherein the test head is used for subjecting the body or at least a region of the body to the sound field during the scanning operation of the surface or at least of a surface section of the body and also for detecting the sound waves reflected on the predetermined number of volume elements during the scanning operation of the surface or at least of the surface section of the body.
